(19) United States
(12) Patent Application Publication
(10) Pub. No.: US 2019/0333416 A1
(43) Pub. Date: Oct. 31, 2019

(54) Concealable Identification Sleeve

(71) Applicant: Jeffrey Lampson, Manchester, CT (US)

(72) Inventor: Jeffrey Lampson, Manchester, CT (US)

(21) Appl. No.: 16/397,277

(22) Filed: Apr. 29, 2019

Related U.S. Application Data
(60) Provisional application No. 62/663,352, filed on Apr. 27, 2018.

(51) Int. Cl. G09F 3/00; G09F 21/02; G09F 7/02

(52) U.S. Cl. CPC G09F 3/005; G09F 2021/023; G09F 7/02; G09F 21/026

(57) ABSTRACT

The concealable identification sleeve (hereafter, “the sleeve”) is configured to be worn on an arm of a user. The sleeve is capable of transitioning from compact and concealed to expanded and highly visible. The sleeve includes a first end having a first ring and a second end having a second ring. The first and second rings each define an opening and include complementary connection mechanisms. A body portion is disposed between the first ring and the second ring. The body transitions from a concealed state to an expanded state between the first and second rings. In the concealed state, the first and second rings are positioned at a first length L₁ from each other and in the expanded state the first and second rings are positioned at a length L₂ from each other that is greater than the first length L₁.

### BACKGROUND

The present disclosure relates to identification devices. More particularly, the present disclosure relates to wearable devices worn by first responders to communicate their identification to officers and civilians nearby.

At any given time, a first responder, such as a law enforcement officer, firefighter, and/or emergency medical technician may be off-duty and among civilians undetected. Also, during certain assignments, law enforcement officers are required to wear plainclothes (civilian clothing), rather than a uniform, as a method of avoiding the detection of their identity as an officer while on-duty. The officers typically keep their identity as an officer hidden from suspects and/or bystanders until identifying themselves as an officer is necessary for the particular assignment.

In the event that an incident occurs, an off-duty first responder cannot effectively engage a threat or provide assistance to injured civilians due to a lack of being able to be properly identified as someone trained to help. In law enforcement specifically, a problem arises in the event that other officers arrive at a crime scene where a conflict between a plainclothes officer and a suspect is taking place. In this scenario, it is difficult for the arriving officer to discern the plainclothes officer from the suspect. As a result, the plainclothes officer is at risk of being confused for the suspect by other officers who are unaware of the identity of the plainclothes officer.

One of the challenges for off duty law enforcement, particularly those who are armed, is to quickly and conspicuously deploy a means of authoritative identification. Traditionally, off-duty personnel are only equipped with a police photo ID and badge, carried together in a wallet. In a situation where it has become necessary to become identified as an officer, the one or two-handed process of displaying a badge and picture ID from a wallet becomes cumbersome, particularly if armed, and fails to offer an officer with a meaningful and conspicuous way of unmistakably identifying their authoritative office and role within a public or private setting.

A current method of reducing the likelihood for misidentification of plainclothes officers includes plainclothes officers strategically wearing a “color of the day.” In this method, an article of clothing and/or accessory of a specified color is worn by the plainclothes officer to signify their identity to other officers. A disadvantage with the “color of the day” and similar approaches is that the inconsistency of the article of clothing and/or color worn by plainclothes officers can cause ambiguity as to the plainclothes officer and/or a suspect's identity. Another disadvantage is that a suspect may be privy to the “color of the day” and detect a plainclothes officer's identity, thereby compromising the officer's assignment.

There is a need in the art for a wearable device that is capable of rapidly transitioning from compact and concealed to expanded and highly visible to communicate the identity of a user when necessary.

### SUMMARY

The concealable identification sleeve (hereafter, “the sleeve”) is configured to be worn on an arm of a user. While on the arm of the user, the sleeve is capable of transitioning from compact and concealed to expanded and highly visible. The sleeve is capable of transitioning at a moment's notice and with minimal effort from the user.

One basic configuration of the sleeve includes a first end having a first ring and a second end having a second ring. The first and second rings each define an opening and include complementary connection mechanisms. A body portion is disposed between the first ring and the second ring. The body may include a reflective element and/or an identification element. The body transitions from a concealed (first) state to an expanded (second) state between the first and second rings. The second end includes a tab to aid in the transition of the sleeve from the first state to the second state. The sleeve may include a receptacle to store the body in when the sleeve is in the first state.

In the first state, the first and second rings are positioned at a first length L₁ from each other and in the second state the first and second rings are positioned at a length L₂ from each other that is greater than the first length L₁. The body extends between the first and second rings to transition from the first state to the second state and retracts between the first and second rings to transition from the second state to the first state.

In another embodiment the first or second end of the sleeve is affixed to a cuff or a sleeve of a garment worn by the user.

Another embodiment includes a method of manufacturing the sleeve. The method includes first step of attaching a first ring having a connection mechanism to an outer end of a cylindrical body. A second step includes attaching a second ring having a connection mechanism complementary to the first ring to an opposing outer end of the body. In the method, advancing the second ring in a first direction extends the body and advancing the second ring in a second direction retracts the body.

### BRIEF DESCRIPTION OF THE DRAWINGS

Aspects of a preferred embodiment will be described in reference to the drawings, wherein like numerals reflect like elements:

FIG. 1 is a perspective view of a representative concealable identification sleeve (hereafter, “the sleeve”) in an expanded state on an arm of a user according to aspects of the disclosure;

FIG. 2 is a perspective view of the sleeve of FIG. 1;

FIG. 3 is a perspective view of the sleeve in a concealed state according to aspects of the disclosure;

FIG. 4 is a partial left end view with emphasis on a second ring of the sleeve of FIG. 1;

FIG. 5 is a perspective view of the sleeve in the concealed state of FIG. 3 with emphasis on an annular cavity;

FIG. 6 is a second embodiment of the sleeve in an expanded state on the arm of the user according to aspects of the disclosure;

FIG. 7 is a third embodiment of the sleeve in an expanded state on the arm of the user according to aspects of the disclosure;

FIG. 8 is a side cross-sectional view of the sleeve of FIG. 5;

FIG. 9A is a side cross-sectional view of a fourth embodiment of the sleeve in a concealed state according to aspects of the disclosure; and

FIG. 9B is a side cross-sectional view of a fifth embodiment of the sleeve in a concealed state according to aspects of the disclosure.

### DETAILED DESCRIPTION

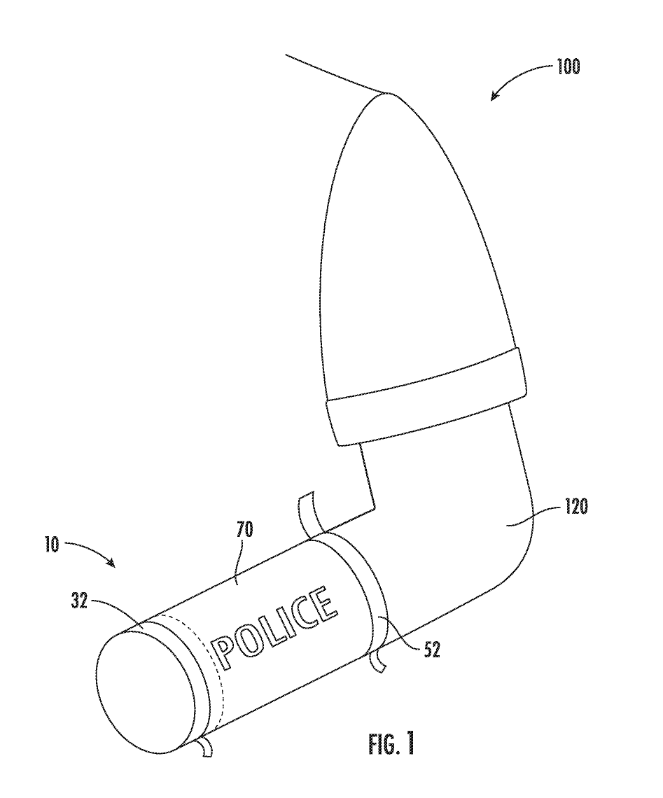

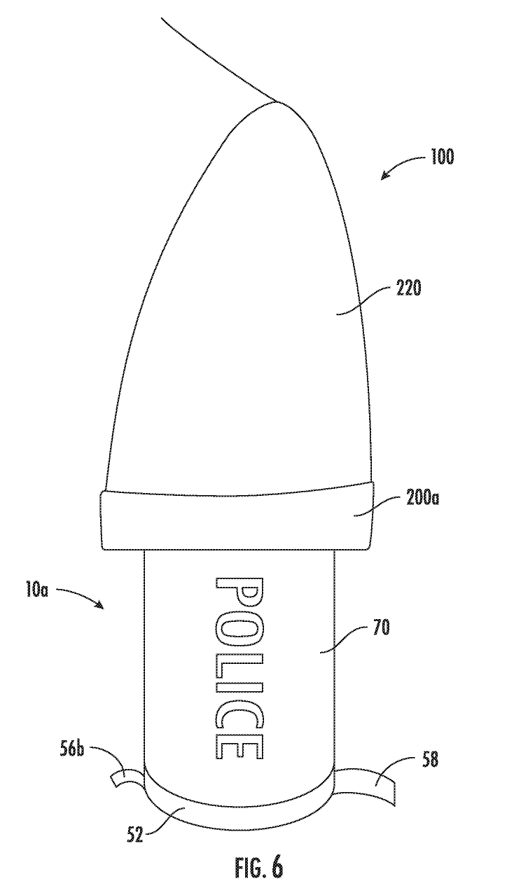

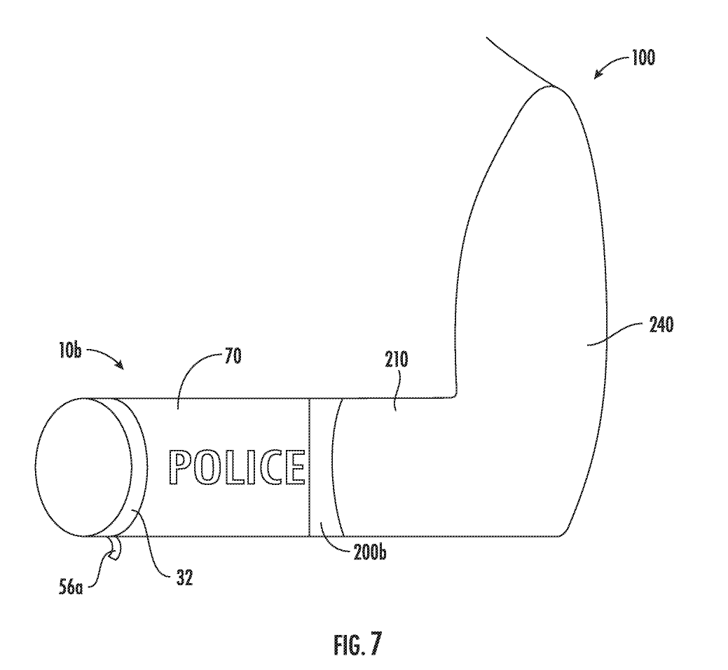

One embodiment of concealable identification sleeve (hereafter, “the sleeve”) according to aspects of the disclosure will now be described with reference to FIGS. 1-9B. The sleeve will generally be referred to by the reference numeral 10. Various materials, methods of construction, methods of manufacture, and methods of fastening will be discussed in the context of the disclosed embodiment. Those skilled in the art will recognize known substitutes for the materials, manufacturing methods, and fastening methods, all of which are contemplated as compatible with the disclosed embodiment and are intended to be encompassed by the appended claims.

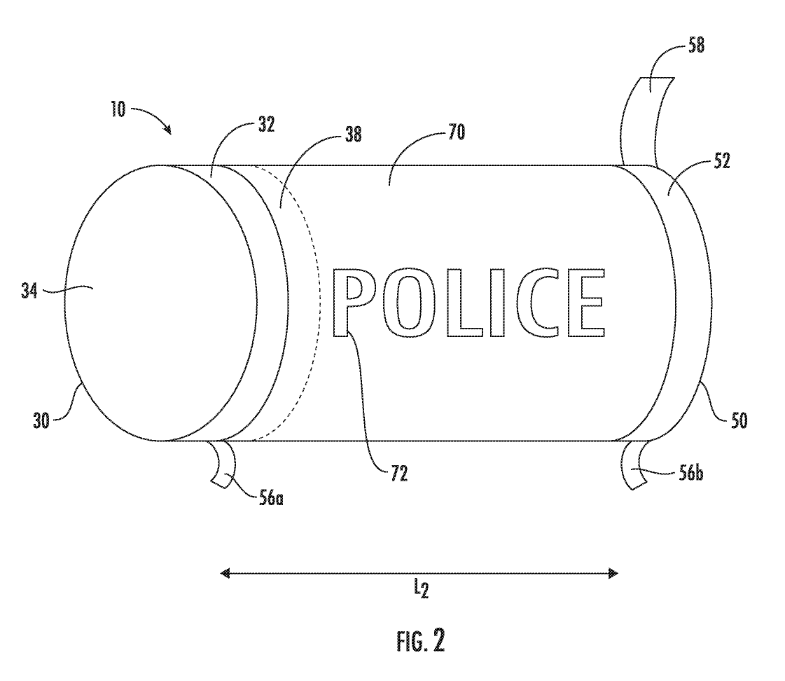

One object of the sleeve 10 is to provide a wearable device that is capable of transitioning from compact and nondescript in appearance to expanded and highly visible on the person of a user 100. When necessary, the sleeve 10 is configured to identify the user 100 (shown in FIG. 2) to others within proximity of the user 100. Another object of the disclosed sleeve 10 is to make the transition from nondescript to high visibility rapid and easy for the user 100. The disclosed sleeve 10 is configured to be worn on the right and/or left arm of the user 100 but will be discussed below with respect to use on one arm 120. The disclosed sleeve 10 incorporates combinations of materials designed to fit, function, and resemble a bracelet and/or fit, function, and resemble the sleeve of a shirt, jacket and/or other garment.

In a first embodiment shown in FIGS. 1 and 2, the disclosed sleeve 10 includes a first end 30, a second end 50, and a cylindrical body portion 70 disposed between the first and second ends 30, 50. When worn by the user 100, the first end 30 is disposed proximate the hand of the arm 120 of the user 100 and the second end 50 is disposed proximate the forearm of the arm 120 of the user 120. In a concealed (first) state, the first and second ends 30, 50 may be coupled to each other. In the concealed state, the body 70 is compact and inconspicuous. In an expanded (second) state, the first and second ends 30, 50 are distant from each other relative to the concealed state. In the expanded state, the body 70 is extended longitudinally between the first and second ends 30, 50 and is highly visible. In the disclosed embodiment, the user 100 of the sleeve 10 is responsible for transitioning the sleeve 10 between the concealed and expanded states in a manner described below.

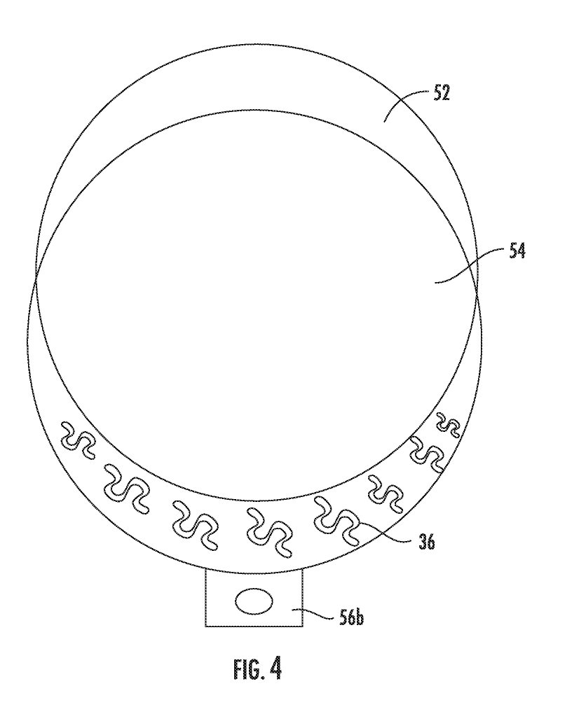

As illustrated by FIG. 2, in the first embodiment, the first end 30 includes a first ring 32 defining a first opening 34 and the second end 50 includes a second ring 52 defining a second opening 54 (shown in FIG. 4). The first and second rings 32, 52 are each attached to opposing outer ends of the body 70. Each ring 32, 52 is configured to radially fit and surround a point on the arm 120 of the user 100. The first and second rings 32, 52 may be semi-circular so that only a portion of the point on the arm 120 is surrounded. In a preferred embodiment, the first and second rings 32, 52 are constructed of elastic, but a person having ordinary skill in the art would appreciate that other materials such as rubber, silicone, plastic, and/or any other compatible material may be suitable for the disclosed sleeve 10. The first and second rings 32, 52 each include a complementary connection mechanism 56a, 56b, respectively. The connection mechanisms 56a, 56b may be a hook and latch configuration, Velcro™, a magnetic coupling, snap button, and/or any other linking device that may be suitable for the disclosed sleeve 10. The first and second ends 30, 50 each include a silicone (or similar material) grip 36 (shown in FIG. 4) on an inner surface for maintaining the position of each ring 32, 52 about a point on the arm 120 of the user 100. In the first embodiment, the second end 50 includes a tab 58 which is pulled by the user 100 to extend the sleeve 10 from the concealed state to the expanded state.

Referring to FIG. 2, the body 70 is configured to extend and retract between the first and second rings 32, 52. In the preferred embodiment, the body 70 is constructed of a collapsible material such as nylon, ripstop, Kevlar™, Lycra™, and/or any other material that may be suitable for the disclosed sleeve 10. The body 70 is preferably comprised of a high visibility color such as fluorescent yellow-green or fluorescent orange and/or a reflective element such as 3M Scotchlite™ reflective material so that the sleeve 10 is noticeable to others within proximity of the user 100. An identification element 72 used to announce the identity of the user is printed along the body 70 in a position that is noticeable to others within proximity of the user 100.

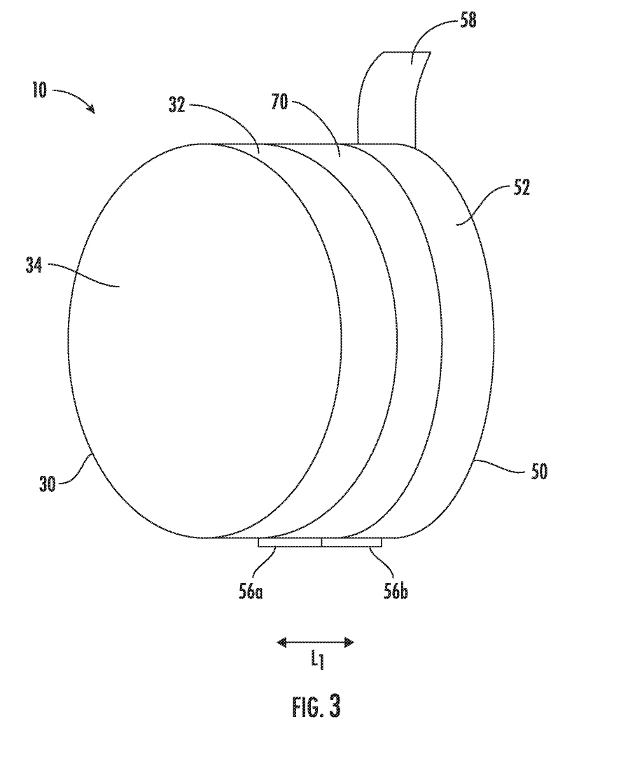

In the concealed state of the first embodiment, shown in FIG. 3, the first and second ends 30, 50 are positioned at a first length L₁ from each other about the wrist of the arm 120 of the user 100. In this configuration, the complimentary connection mechanisms 56a, 56b of the first and second rings 32, 52 are engaged. When the connection mechanisms 56a, 56b are engaged, the body 70 is collapsed in a bunched and/or pleated configuration between the first and second rings 32, 52, making the body 70 inconspicuous (concealed) to others within proximity of the user 100. In this arrangement, the first ring 32 is closer to the hand of the user 100 relative to the position of the second ring 52. To deploy the body 70 and transition the sleeve 10 from the concealed state to the expanded state, the user 100 pulls the tab 58 in a first direction up the forearm of the user 100 away from the hand. As the second ring 52 advances in the first direction up the arm 120 of the user, the body 70 is simultaneously extended.

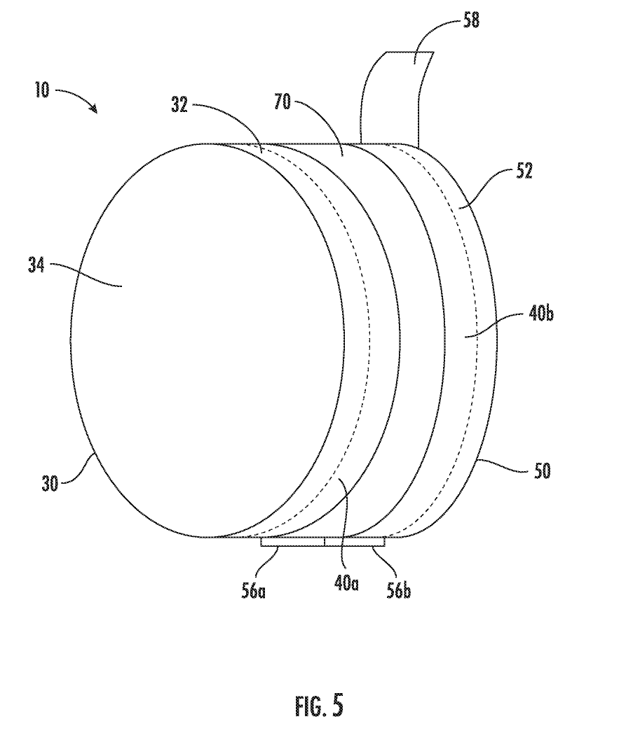

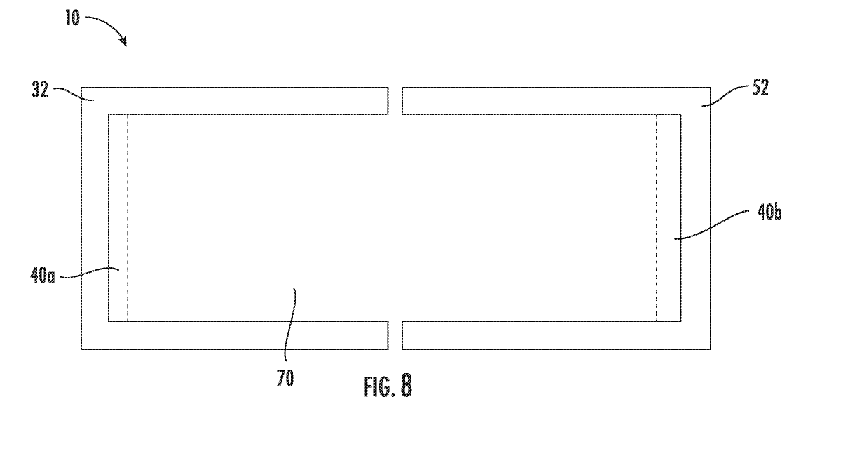

As shown in FIG. 2, the first end 30 and/or second end 50 of the sleeve 10 may include a pouch-like receptacle 38 (shown in dashed lines) to hold and conceal the body 70 in the concealed state. As shown in FIG. 5, the first end 30 and/or the second end 50 may each include an annular cavity 40a, 40b, respectively, to envelope the body 70 in the concealed state. As shown in FIG. 8, the body 70 may be tucked into the receptacle 38 and/or the cavities 40a, 40b so that the first and second rings 32, 52 are adjacent or contiguous to each other. Alternatively, the body 70 may be folded over the first ring 32 so that the body 70 envelopes the first ring 32. The body 70 may include an interior fabric that includes an aesthetic and/or pattern that is different from the high visibility exterior fabric discussed above. The inner fabric is exposed when the body 70 is reversed and folded over the first ring 32.

Referring to FIGS. 1 and 2, when the body 70 is fully extended, the sleeve 10 is in the expanded state. In the expanded state, the first and second ends 30, 50 are positioned at a second length L₂ from each other that is greater than the first length L₁. In this configuration, the body 70 is extended along the arm 120 of the user 100 and is conspicuous to others within proximity of the user 100. To return the sleeve 10 to the concealed state, the user 100 advances the second ring 52 in a second direction toward the hand of the user 100 and/or advances the first ring 32 in the first direction toward the second ring 52. As shown in FIG. 3, the complementary connection mechanisms 56a, 56b can be reengaged when the first and second rings 32, 52 are repositioned at a length L₁ from each other.

Referring back to FIGS. 2 and 3, in the concealed state of an alternative orientation of the first embodiment, the first and second ends 30, 50 are positioned at the first length L₁ from each other proximate the elbow of the arm 120 of the user 100. In this arrangement, the orientation of the sleeve 10 of the first embodiment is inverted and the second ring 52 is closer to the hand of the user 100 relative to the position of the first ring 32. To deploy the body 70 and transition the sleeve 10 from the concealed state to the expanded state, the user pulls the tab 58 in the second direction down the forearm of the user 100 toward the hand. As the second ring 52 advances in the second direction down the arm 120 of the user 100, the body 70 is simultaneously extended.

In the concealed state of a second embodiment shown in FIGS. 2, 3 and 6, where like parts are given the same reference numerals, the first and second ends 30, 50 are positioned at the first length L₁ from each other proximate the elbow of the user 100 and the first ring 32 is affixed to a cuff 200a of a short-sleeve garment 220 worn by the user 100. In this arrangement, the orientation of the sleeve 10 of the first embodiment is inverted and the second ring 52 is closer to the hand of the user 100 relative to the position of the first ring 32. To deploy the body 70 and transition the sleeve 10a from the concealed state to the expanded state, the user pulls the tab 58 in the second direction down the forearm of the user 100 toward the hand. As the second ring 52 advances in the second direction down the arm 120 of the user 100, the body 70 is simultaneously extended.

In the concealed state of a third embodiment, illustrated in FIGS. 2, 3 and 7, the first and second ends 30, 50 are positioned at a first length L₁ from each other about the wrist of the user 100 and the second ring 52 is affixed to a cuff 200b included on a long-sleeve garment 240 worn by the user 100. In this arrangement, the first ring 32 is closer to the hand of the user 100 relative to the position of the second ring 52. To deploy the body 70 and transition the sleeve 10b from the concealed state to the expanded state, the user 100 pulls the cuff 200b and/or sleeve 210 of the garment in the first direction up the forearm and away from the hand. As the second ring 52 advances in the first direction up the arm 120 of the user 100, the body 70 is simultaneously extended.

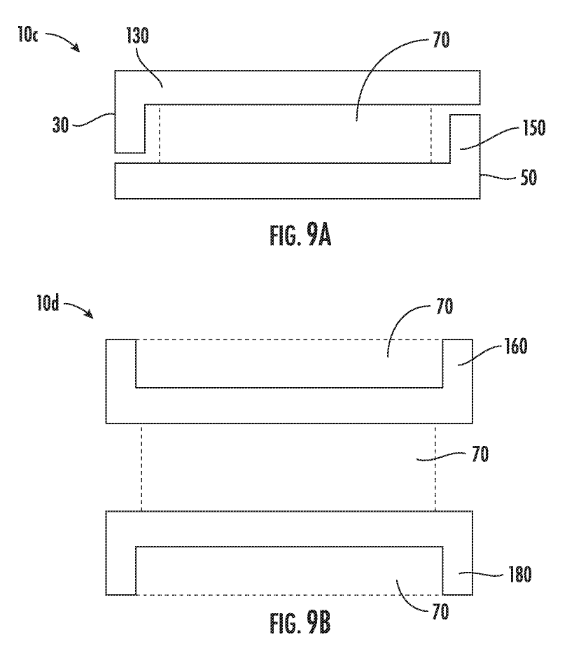

In the concealed state of a fourth embodiment, shown in FIG. 9A, the first and second ends 30, 50 comprise a first interlocking L-shaped member 130 and a second interlocking L-shaped member 150, respectively. To deploy the body 70 (shown in dashed lines) and transition the sleeve 10c from the concealed state to the expanded state, the second member 150 is pulled in the first direction up the forearm and away from the hand of a user. As the second member 150 advances in the first direction up the arm of the user, the body 70 is simultaneously extended.

In the concealed state of a fifth embodiment, shown in FIG. 9B, the sleeve 10d comprises a top member 160 and a bottom member 180. To deploy the body 70 (shown in dashed lines) and transition the sleeve 10d from the concealed state to the expanded state, the body 70 is pulled out of the top and bottom members 160, 180 and extended in the first direction up the forearm and away from the hand of a user.

While a preferred embodiment of the disclosed concealable identification sleeve has been set forth for purposes of illustration, the foregoing description should not be deemed a limitation of the invention. Accordingly, various modifications, adaptations and alternatives may occur to one skilled in the art without departing from the spirit of the disclosure and the scope of the claimed coverage.

What is claimed:

1. A concealable sleeve for being worn on an arm of a user comprising:
a first end having a first ring;
a second end having a second ring;
a body portion disposed between the first ring and the second ring; and
wherein, said body transitions from a first state to a second state between said first and second rings.

2. The sleeve of claim 1, wherein in the first state the first and second rings are positioned at a first length L₁ from each other and in a second state the first and second rings are positioned at a length L₂ from each other that is greater than the first length L₁.

3. The sleeve of claim 1, wherein the body extends between the first and second rings to transition from the first state to the second state and retracts between the first and second rings to transition from the second state to the first state.

4. The sleeve of claim 1, wherein the first and second rings each define an opening.

5. The sleeve of claim 1, wherein the first end includes a ring having a connection mechanism and the second end includes a ring having a connection mechanism complementary to the first end.

6. The sleeve of claim 1, wherein the first and second ends each include a grip on an inner surface.

7. The sleeve of claim 3, wherein the first end of the sleeve includes a receptacle and the body is stored in the receptacle in the first state.

8. The sleeve of claim 1, wherein one of the first or second end is affixed to the cuff of a garment worn by the user.

9. The sleeve of claim 1, wherein the second end includes a tab to aid the transition of the sleeve from the first state to the second state.

10. The sleeve of claim 1, wherein the sleeve includes a reflective element.

11. The sleeve of claim 1, wherein the body includes an identification element.

12. A concealable identification sleeve for being worn by a user comprising:
a first end having an opening;
a second end having an opening;
a body portion disposed between the first end and the second end, said body portion capable of transitioning between an concealed form and an expanded form.

13. The sleeve of claim 12, wherein in the concealed form the first end and the second end are a first length L₁ from each other and in the expanded form the first end and the second end are a second length L₂ from each other that is greater than L₁.

14. A method of manufacturing a concealable identification sleeve for being worn by a user comprising the steps of:
attaching a first ring having a connection mechanism to an outer end of a cylindrical body;
attaching a second ring having a connection mechanism complementary to the first ring to an opposing outer end of the body;
wherein advancing the second ring in a first direction extends the body and advancing the second ring in a second direction retracts the body.

15. The method according to claim 14, comprising the step of introducing a silicone grip to an inner surface of the first and second rings.

16. The method according to claim 14, comprising the step of attaching the second ring to the cuff of a garment.

17. The method according to claim 14, comprising the step of using a collapsible material for the body.
